(19) United States
(12) Patent Application Publication
(10) Pub. No.: US 2026/0295843 A1
(43) Pub. Date: Oct. 1, 2026

(54) ROBOT SYSTEM, MARKER, AND CALIBRATION METHOD

(71) Applicant: SEIKO EPSON CORPORATION, Tokyo (JP)

(72) Inventors: Kazufumi OYA, MATSUMOTO-SHI (JP); Shuya SEGAWA, CHINO-SHI (JP); Kazuyuki MIYASHITA, SHIOJIRI-SHI (JP); Kanji OKUYAMA, SHIOJIRI-SHI (JP)

(21) Appl. No.: 19/576,474

(22) Filed: Mar. 24, 2026

(30) Foreign Application Priority Data
Mar. 26, 2025 (JP) 2025-051244

(51) Int. Cl. B25J 9/16; B25J 19/00

(52) U.S. Cl. CPC B25J 9/1692; B25J 9/1697; B25J 19/00

(57) ABSTRACT

In a robot system, a control device drives a robot arm and engages a positioning portion with a marker, thereby aligning the marker with the positioning portion, and acquires a first position that is a position of the positioning portion in a robot coordinate system in a state in which the positioning portion is engaged with the marker, images the marker after the alignment using the imaging device, and acquires a second position that is a position of the marker in the image coordinate system, based on an obtained image, and performs calibration between the robot coordinate system and the image coordinate system based on the first position and the second position.

### CROSS-REFERENCE TO RELATED APPLICATIONS

The present application is based on, and claims priority from JP Application Serial Number 2025-051244, filed Mar. 26, 2025, the disclosure of which is hereby incorporated by reference herein in its entirety.

### BACKGROUND OF THE INVENTION

### 1. Technical Field

The present disclosure relates to a robot system, a marker, and a calibration method.

### 2. Related Art

In the related art, there is known a robot system including a robot that performs predetermined work on a workpiece as a work object, a camera that images the workpiece, and a control device, in which the control device controls drive of the robot based on an image captured by the camera (hereinafter also simply referred to as a “camera image”). In such a robot system, before the predetermined work is performed, calibration (correspondence) between an image coordinate system of the camera image and a robot coordinate system serving as a reference for control of the robot is required. As a method for the calibration, for example, JP-A-8-210816 is known.

In the calibration method described in JP-A-8-210816, first, a reference point on a calibration jig is visually touched up using a touch-up hand to acquire a position of the calibration jig in the robot coordinate system, and a coordinate transformation matrix between the robot coordinate system and a calibration jig coordinate system is obtained. Next, the calibration jig is imaged by a camera mounted on the robot, and a coordinate transformation matrix between the calibration jig coordinate system and a camera coordinate system is obtained from the captured image.

In the calibration method described in JP-A-8-210816, since a touch-up hand is visually touched up to a reference point on the calibration jig, there is a possibility that variation may occur depending on an operator. As a result, calibration accuracy is degraded or varies.

### SUMMARY OF THE INVENTION

According to an aspect of the present disclosure, there is provided a robot system including a robot including a robot arm and a positioning portion disposed at a tip end portion of the robot arm;
a marker that is disposed on a work surface, is configured to slide with respect to the work surface, and is configured to engage with the positioning portion;
an imaging device configured to image the marker; and
a control device configured to perform calibration between a robot coordinate system set in the robot and an image coordinate system set in the imaging device, in which
the control device
   drives the robot arm and engages the positioning portion with the marker, thereby aligning the marker with the positioning portion, and acquires a first position that is a position of the positioning portion in the robot coordinate system,
   images the marker after the alignment using the imaging device, and acquires a second position that is a position of the marker in the image coordinate system, based on an obtained image, and
   performs calibration between the robot coordinate system and the image coordinate system based on the first position and the second position.

According to another aspect of the present disclosure, there is provided a marker used for calibration between a robot coordinate system set in a robot having a robot arm and a positioning portion disposed at a tip end portion of the robot arm, and an image coordinate system set in an imaging device that images a work surface,
the marker being disposed on the work surface and being configured to slide with respect to the work surface, the marker including:
a base portion configured to extend in a direction orthogonal to the work surface and include a recessed portion formed in a surface facing the positioning portion; and
an annular flange portion configured to protrude outward from the base portion in a plan view of the work surface, in which
the marker is configured to align with the positioning portion by insertion of the positioning portion into the recessed portion.

According to still another aspect of the present disclosure, there is provided a calibration method in a robot system including
a robot including a robot arm and a positioning portion disposed at a tip end portion of the robot arm,
a marker that is disposed on a work surface, is configured to slide with respect to the work surface, and is configured to engage with the positioning portion, and an imaging device configured to image the marker,
for performing calibration between a robot coordinate system set in the robot and an image coordinate system set in the imaging device, the method including:
driving the robot arm and engaging the positioning portion with the marker, thereby aligning the marker with the positioning portion, and acquiring a first position that is a position of the positioning portion in the robot coordinate system;
imaging the marker after the alignment using the imaging device and acquiring a second position that is a position of the marker in the image coordinate system, based on an obtained image; and
performing calibration between the robot coordinate system and the image coordinate system based on the first position and the second position.

### BRIEF DESCRIPTION OF DRAWINGS

FIG. 1 is an overall configuration diagram of a robot system according to a first embodiment.

FIG. 2 is a diagram showing a tool and a marker used for calibration.

FIG. 3 is a diagram showing an example of an image obtained by a fixed camera.

FIG. 4 is a cross-sectional view of the marker.

FIG. 5 is a top view of the marker.

FIG. 6 is a cross-sectional view showing a state in which the marker and the positioning portion are engaged.

FIG. 7 is a flowchart showing a calibration step.

FIG. 8 is a cross-sectional view showing a jig that teaches an insertion height of the tool.

FIG. 9 is a view showing a state in which the positioning portion abuts the jig.

FIG. 10 is a diagram showing an example of disposition of markers.

FIG. 11 is a diagram showing a state in which the positioning portion is positioned directly above the marker.

FIG. 12 is a diagram showing a movement of the marker when the positioning portion is inserted into the marker.

FIG. 13 is a diagram showing an example of an image acquired after alignment.

FIG. 14 is a diagram showing an example of an image obtained by capturing a marker before the alignment.

FIG. 15 is a diagram showing a state in which the positioning portion is positioned directly above the marker.

FIG. 16 is a cross-sectional view showing a state in which the marker and the positioning portion are engaged with each other.

FIG. 17 is a diagram showing an example of an image obtained by capturing the marker after the alignment.

FIG. 18 is a diagram showing an example of an image obtained by capturing the marker before the alignment.

FIG. 19 is a diagram showing a state in which the positioning portion is positioned directly above the marker.

FIG. 20 is a cross-sectional view showing a state in which the marker and the positioning portion are engaged with each other.

FIG. 21 is a diagram showing an example of an image obtained by capturing the marker after the alignment.

FIG. 22 is a diagram showing a configuration of a robot system according to a second embodiment.

FIG. 23 is a diagram showing a state in which the positioning portion is positioned directly above the marker.

FIG. 24 is a diagram showing a state in which the positioning portion is inserted into the marker.

FIG. 25 is a diagram showing a state in which a robot camera is positioned at an imaging position.

FIG. 26 is a diagram showing an example of an image obtained by capturing the marker after the alignment.

FIG. 27 is a diagram showing an example of nine images obtained by capturing the marker after the alignment.

FIG. 28 is a diagram showing an image obtained by compositing the nine images shown in FIG. 27.

FIG. 29 is a diagram showing a positioning portion of a robot system according to a third embodiment.

FIG. 30 is a diagram for describing a method of using the positioning portion.

FIG. 31 is a diagram for describing a method of using the positioning portion.

FIG. 32 is a diagram showing a work surface of a robot system according to a fourth embodiment.

### DETAILED DESCRIPTION OF THE INVENTION

Hereinafter, a robot system, a marker, and a calibration method of the present disclosure will be described in detail based on preferred embodiments shown in the accompanying drawings.

### First Embodiment

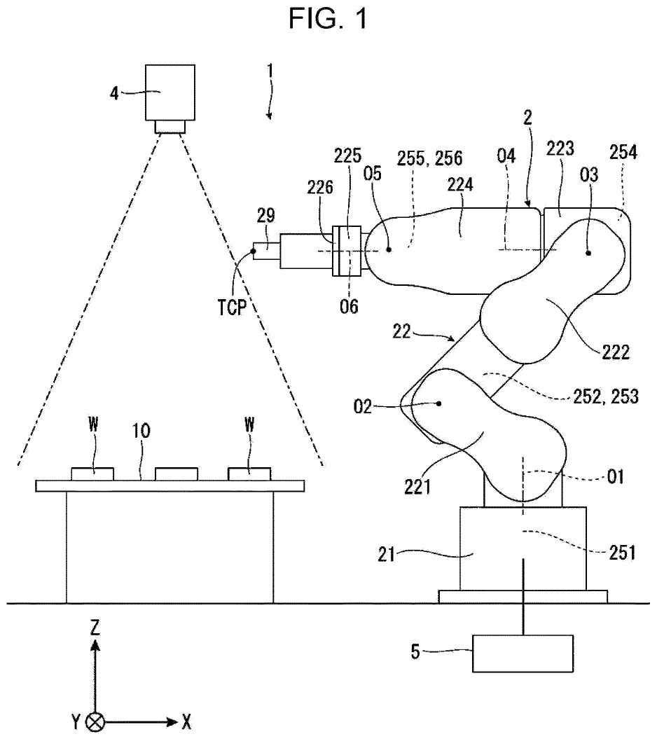

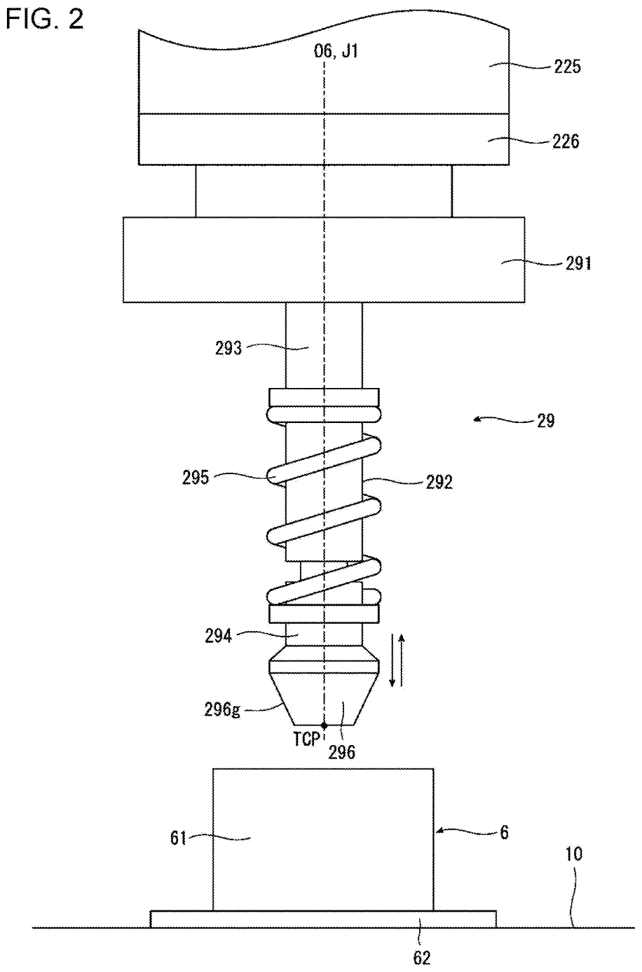

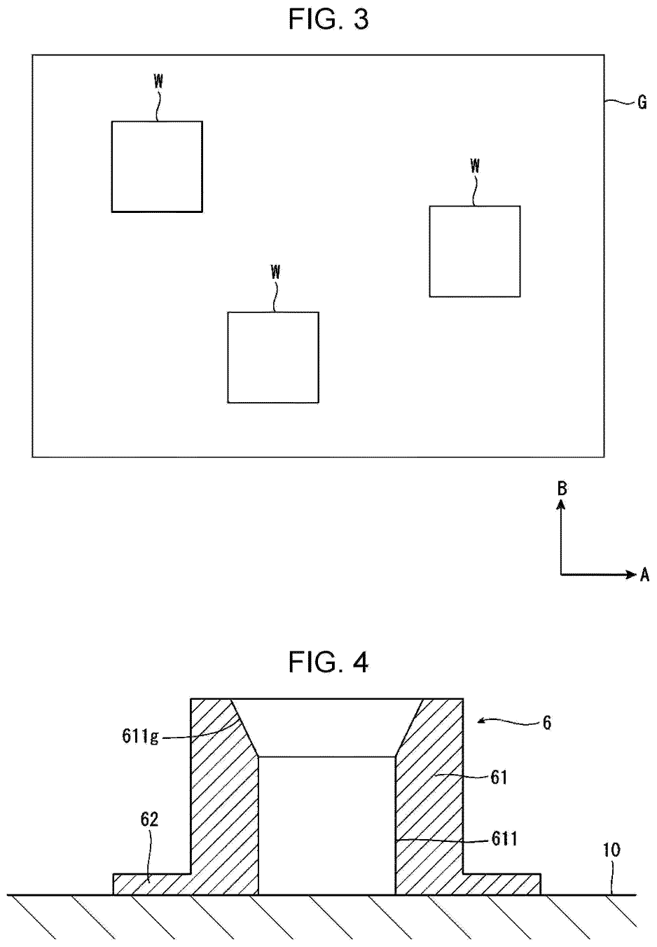

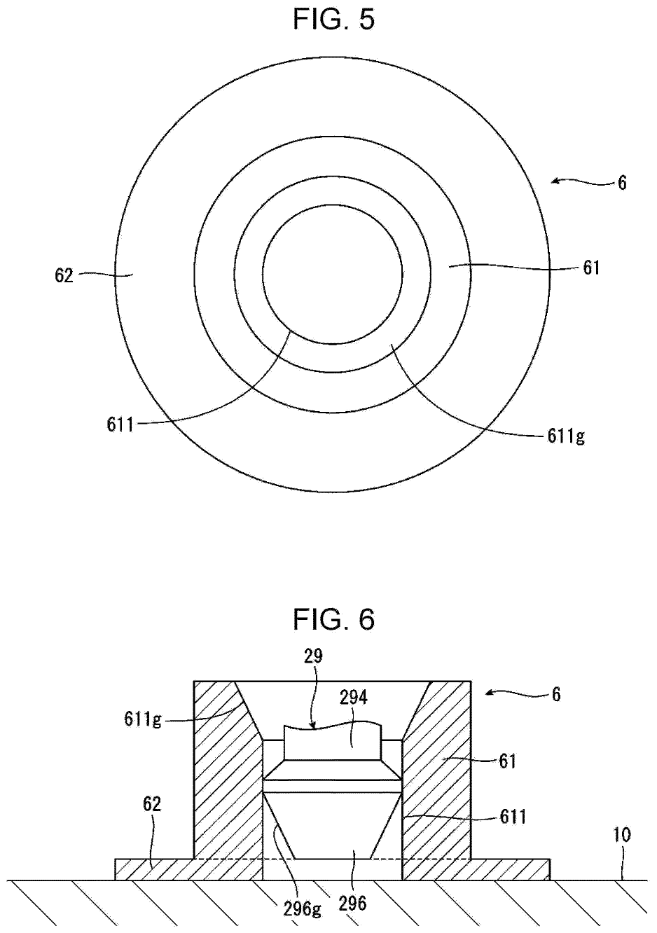

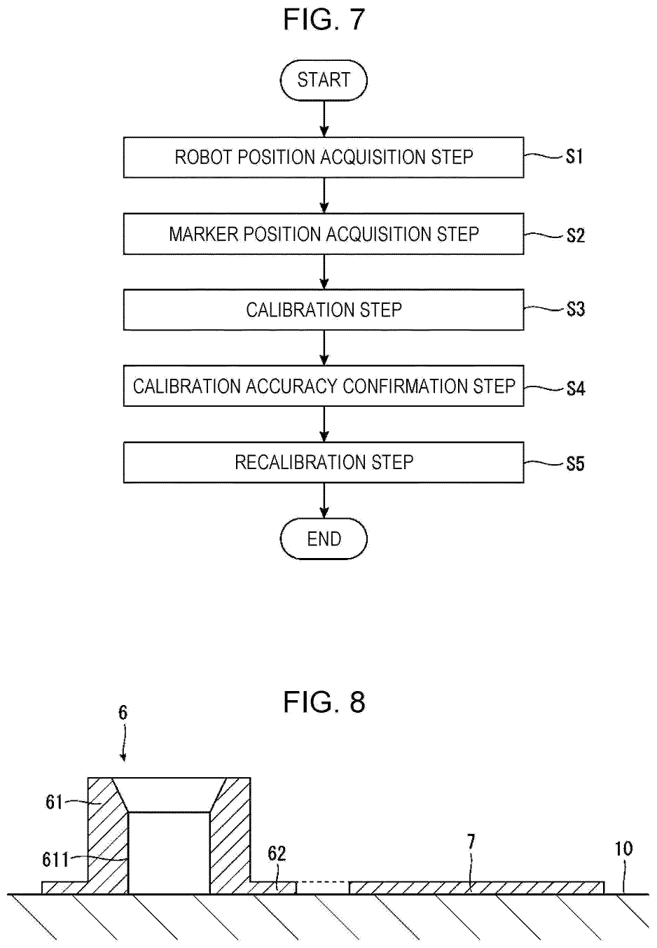

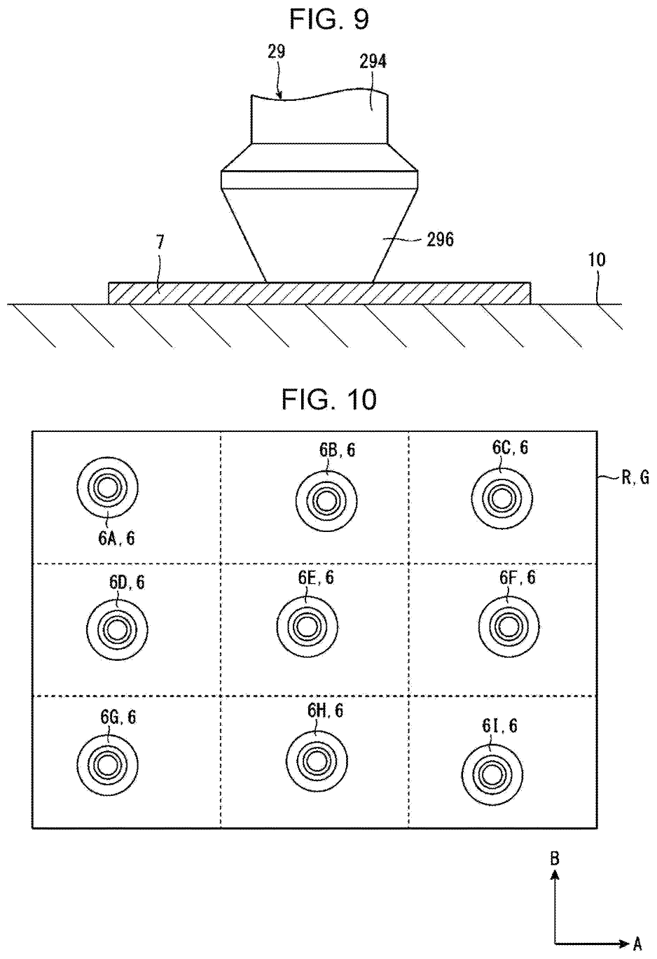

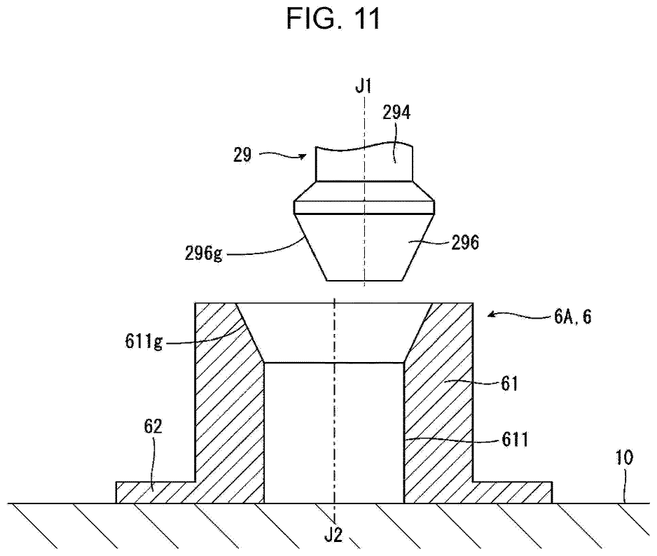

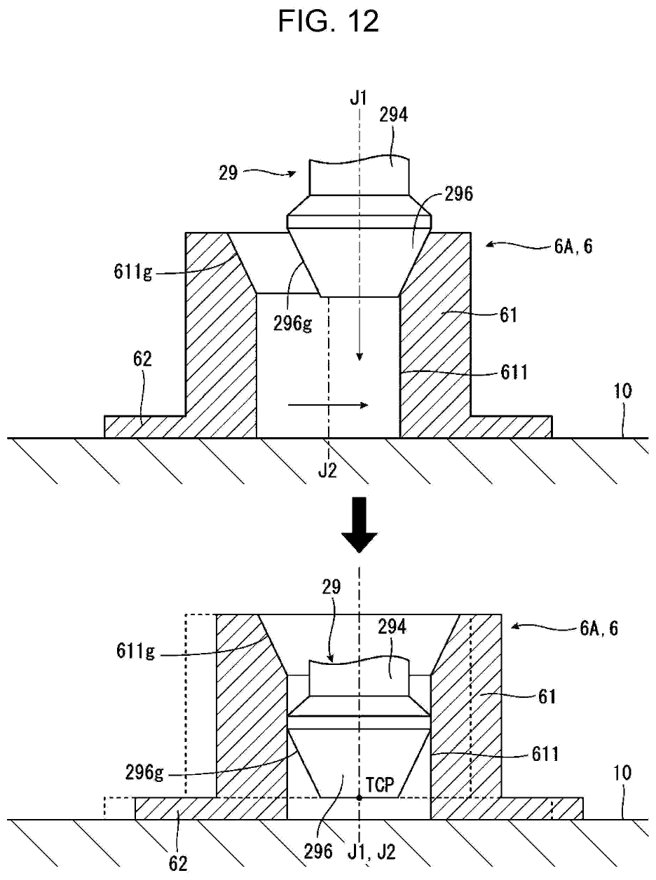

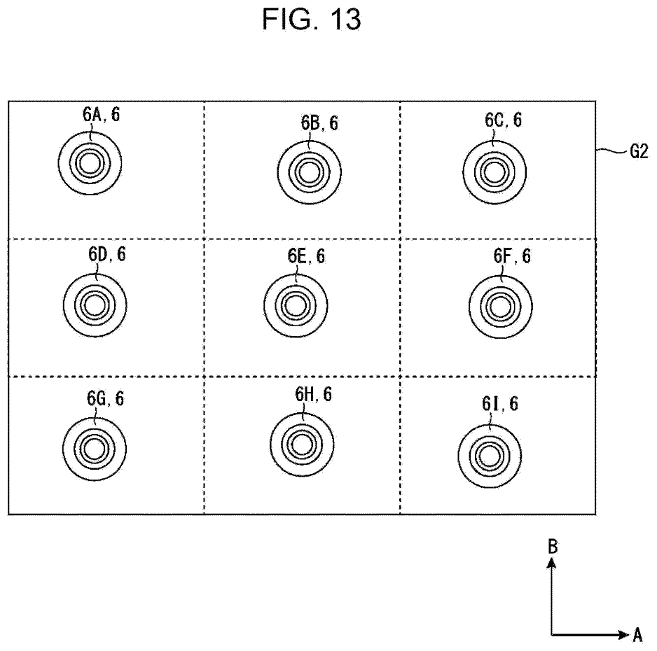

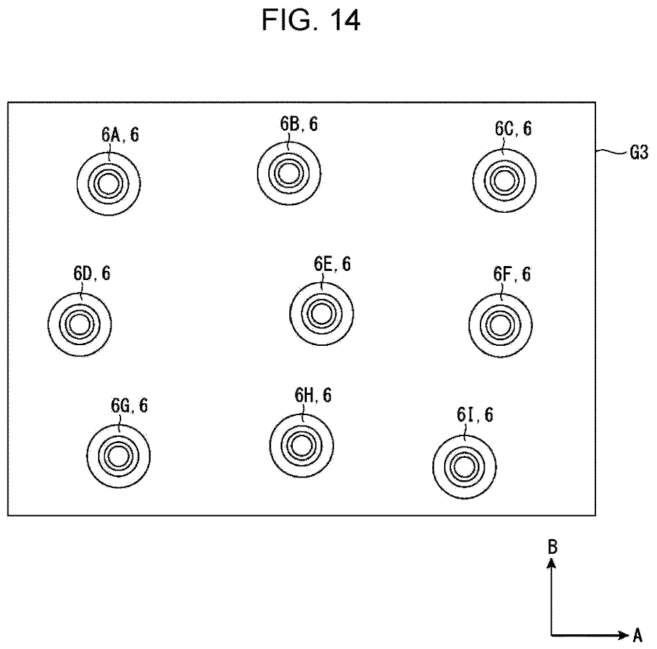

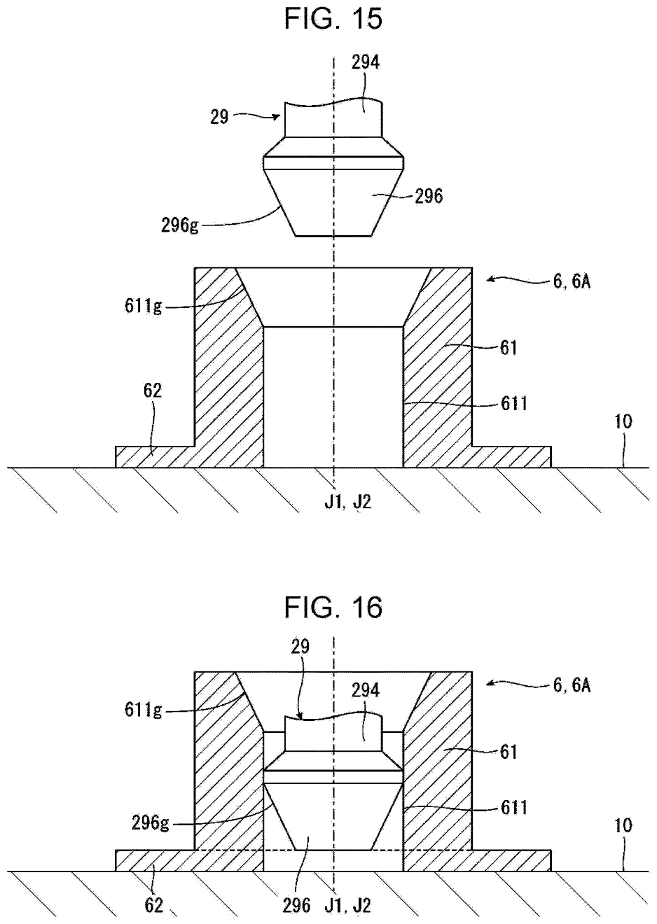

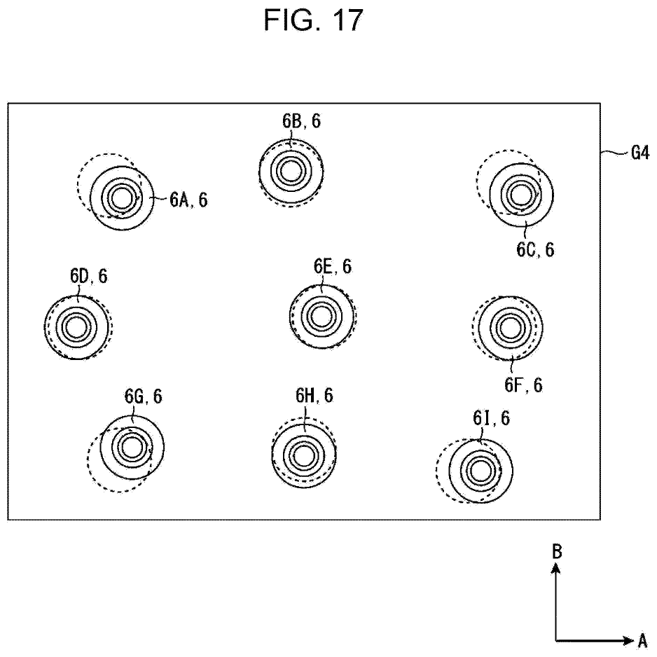

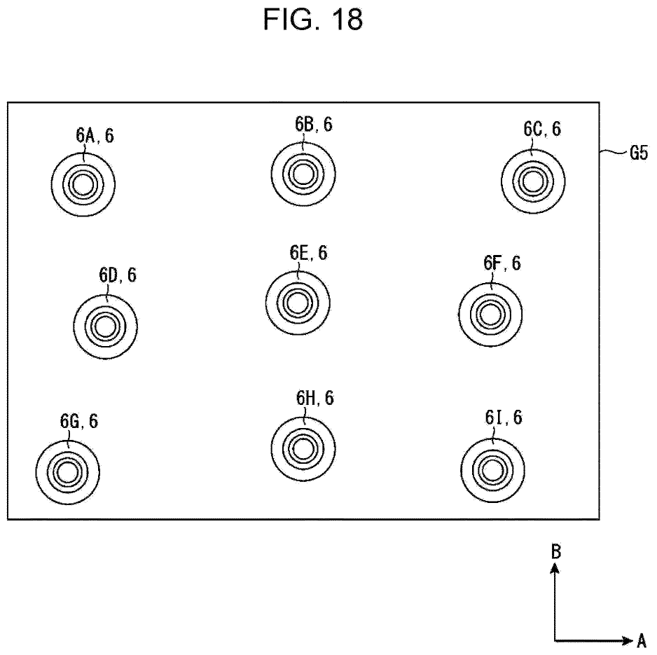

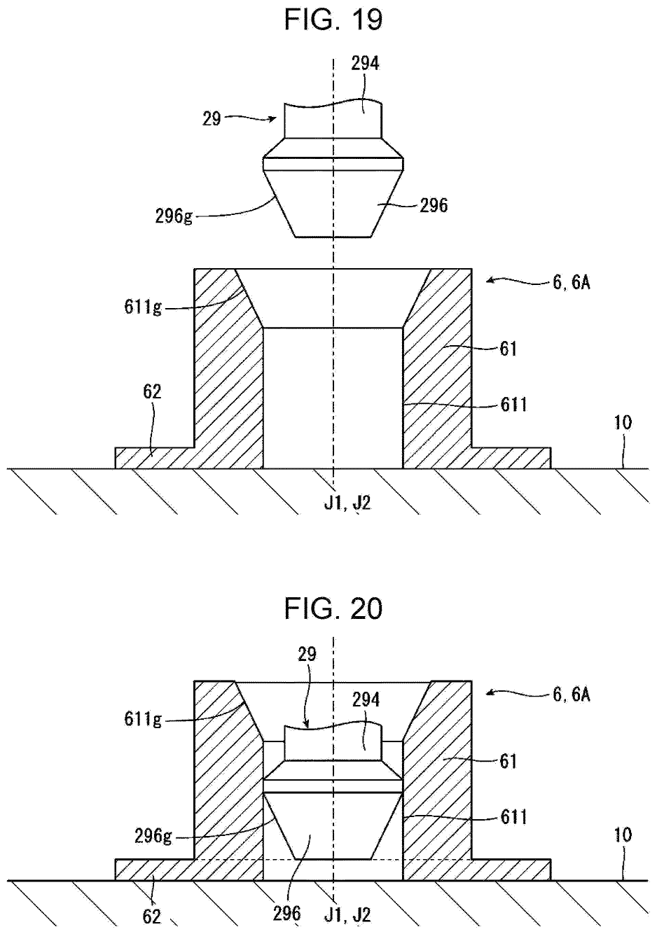

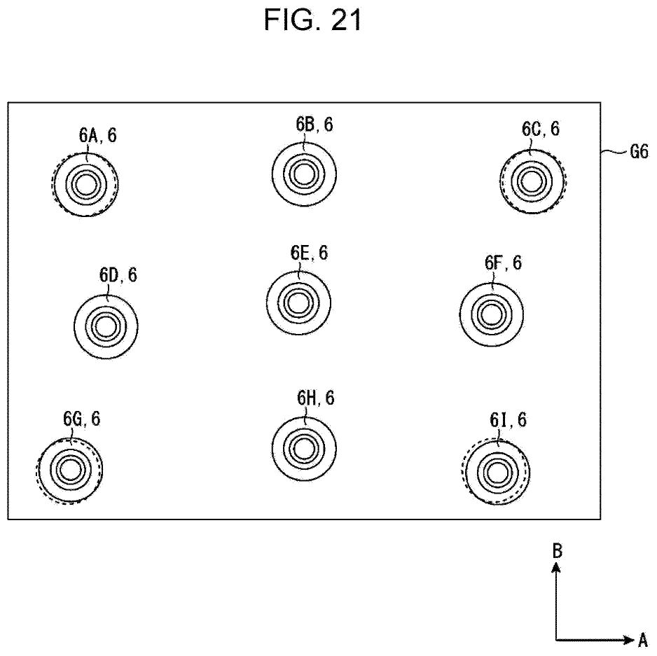

FIG. 1 is an overall configuration diagram of a robot system according to a first embodiment. FIG. 2 is a diagram showing a tool and a marker used for calibration. FIG. 3 is a diagram showing an example of an image obtained by a fixed camera. FIG. 4 is a cross-sectional view of the marker. FIG. 5 is a top view of the marker. FIG. 6 is a cross-sectional view showing a state in which the marker and the positioning portion are engaged. FIG. 7 is a flowchart showing a calibration step. FIG. 8 is a cross-sectional view showing a jig that teaches an insertion height of the tool. FIG. 9 is a view showing a state in which the positioning portion abuts the jig. FIG. 10 is a diagram showing an example of disposition of markers. FIG. 11 is a diagram showing a state in which a positioning portion is positioned directly above a marker. FIG. 12 is a diagram showing a movement of the marker when the positioning portion is inserted into the marker. FIG. 13 is a diagram showing an example of an image acquired after alignment. FIG. 14 is a diagram showing an example of an image obtained by capturing a marker before the alignment. FIG. 15 is a diagram showing a state in which a positioning portion is positioned directly above a marker. FIG. 16 is a cross-sectional view showing a state in which the marker and the positioning portion are engaged. FIG. 17 is a diagram showing an example of an image obtained by capturing the marker after the alignment. FIG. 18 is a diagram showing an example of an image obtained by capturing the marker before the alignment. FIG. 19 is a diagram showing a state in which the positioning portion is positioned directly above the marker. FIG. 20 is a cross-sectional view showing a state in which the marker and the positioning portion are engaged. FIG. 21 is a diagram showing an example of an image obtained by capturing the marker after the alignment.

A robot system 1 shown in FIG. 1 includes a robot 2 that performs predetermined work on a workpiece W as a work object placed on a work surface 10, a fixed camera 4 as an imaging portion fixed in a space, and a control device 5 as a control portion that controls drive of the robot 2. Each of these portions is communicably connected by wire, wireless, or the like. As shown in FIG. 2, the robot system 1 further includes a marker 6 used when performing calibration (correspondence) between an image coordinate system set in the fixed camera 4 and a robot coordinate system set in the robot 2. In such a robot system 1, first, the calibration between the image coordinate system and the robot coordinate system is performed using the marker 6, and then, the drive of the robot 2 is controlled based on the image captured by the fixed camera 4, and the predetermined work is performed on the workpiece W.

Hereinafter, each portion configuring the robot system 1 will be described in order.

### Robot 2

The robot 2 is a six-axis robot having six rotation axes, and as shown in FIG. 1, includes a base 21 fixed to a floor, a ceiling, or the like, and a robot arm 22 coupled to the base 21. The robot arm 22 includes a first arm 221 rotatably coupled to the base 21 about a first rotation axis O1, a second arm 222 rotatably coupled to the first arm 221 about a second rotation axis O2, a third arm 223 rotatably coupled to the second arm 222 about a third rotation axis O3, a fourth arm 224 rotatably coupled to the third arm 223 about a fourth rotation axis O4, a fifth arm 225 rotatably coupled to the fourth arm 224 about a fifth rotation axis O5, and a sixth arm 226 rotatably coupled to the fifth arm 225 about a sixth rotation axis O6. In addition, the robot 2 has a tool 24 mounted on a tip end portion of the sixth arm 226. The tool 24 can be appropriately selected according to work to be executed by the robot 2.

In addition, a tool center point (hereinafter also referred to as a “TCP”) as a control point is set in the robot arm 22. The position and orientation of the TCP are the reference for the position and orientation of the robot arm 22. In the present embodiment, the TCP is set at a tip end of the tool 24, but the position of the TCP is not particularly limited.

As shown in FIG. 1, the robot 2 includes a first drive device 251 configured to rotate the first arm 221 with respect to the base 21, a second drive device 252 configured to rotate the second arm 222 with respect to the first arm 221, a third drive device 253 configured to rotate the third arm 223 with respect to the second arm 222, a fourth drive device 254 configured to rotate the fourth arm 224 with respect to the third arm 223, a fifth drive device 255 configured to rotate the fifth arm 225 with respect to the fourth arm 224, and a sixth drive device 256 configured to rotate the sixth arm 226 with respect to the fifth arm 225. Each of the first to sixth drive devices 251 to 256 includes, for example, a motor, a reduction gear that reduces rotation of the motor and transmits the reduced rotation to the arm, and an encoder that detects an amount of rotation of the motor (an amount of rotation of the arm). The drive of the first to sixth drive devices 251 to 256 is independently controlled by the control device 5.

A robot coordinate system used to control the drive of the robot 2 is set in the robot 2. The robot coordinate system is a three-dimensional orthogonal coordinate system determined by an X-axis, a Y-axis, and a Z-axis orthogonal to each other. In the present embodiment, the orthogonal coordinate system is set such that the Z-axis extends along a vertical direction. In addition, for example, a unit of the robot coordinate system is “mm”.

In addition, as shown in FIG. 2, the robot 2 has a tool 29 for performing calibration between the image coordinate system and the robot coordinate system. During calibration, the tool 24 is removed from the sixth arm 226, and the tool 29 is mounted instead. The tool 29 includes a base portion 291 mounted on the sixth arm 226 and a positioning portion 292 protruding from the base portion 291 along the sixth rotation axis O6. A tip end portion of the positioning portion 292 is configured to be insertable into the marker 6. In addition, the positioning portion 292 includes a fixed portion 293 fixed to the base portion 291, a movable portion 294 configured to slide with respect to the fixed portion 293 in a direction along the sixth rotation axis O6, and a coil spring 295 as a biasing portion positioned between the fixed portion 293 and the movable portion 294 and configured to bias the movable portion 294 toward a tip end side with respect to the fixed portion 293. With such a configuration, the movable portion 294 is capable of retreating toward the fixed portion 293 while compressing the coil spring 295. As a result, impact generated when an insertion portion 296 is inserted into the marker 6 can be effectively absorbed and alleviated. Further, a convex insertion portion 296 to be inserted into the marker 6 is disposed at the tip end portion of the movable portion 294. The insertion portion 296 has a substantially truncated conical shape (tapered shape) at the tip end portion, and an outer diameter thereof is reduced toward a tip end side. An outer peripheral surface of the insertion portion 296 functions as a guide surface 296g that guides the insertion of the insertion portion 296 into the marker 6. Further, above the guide surface 296g, a side surface extending along a vertical direction is formed around the guide surface 296g. In the present embodiment, the side surface is continuous with the guide surface 296g, however, the side surface and the guide surface 296g may be discontinuous, and, for example, a step, a protrusion, or another surface may be provided between the side surface and the guide surface 296g.

Although the robot 2 is described above, the robot 2 is not particularly limited. For example, the number of arms included in the robot arm 22 may be one to five or seven or more. Further, the robot 2 may be, for example, a SCARA robot (horizontal articulated robot), a dual-arm robot having two robot arms 22, or the like.

### Fixed Camera 4

As shown in FIG. 1, the fixed camera 4 is positioned above the work surface 10, and a relative position with the work surface 10 is fixed. In addition, the fixed camera 4 images the workpiece W on the work surface 10. The fixed camera 4 is a digital camera including a lens and an area image sensor. In addition, as shown in FIG. 3, the image coordinate system is set for an image G acquired by the fixed camera 4. The image coordinate system is a two-dimensional orthogonal coordinate system determined by an A-axis along a horizontal direction and a B-axis along a vertical direction of the image G. In addition, for example, a unit of the image coordinate system is “pixel”. Here, in order for the control device 5 to recognize the workpiece W on the work surface 10 based on the image G and to control the drive of the robot 2 based on the recognition result, calibration between the image coordinate system and the robot coordinate system is required. The calibration method will be described later.

Although the fixed camera 4 is described above, the configuration and the disposition of the fixed camera 4 are not particularly limited.

### Control Device 5

The control device 5 controls the drive of the robot 2 and the fixed camera 4, respectively. The control device 5 performs calibration between the image coordinate system set in the fixed camera 4 and the robot coordinate system set in the robot 2. Such a control device 5 is configured by a computer, for example, and includes a processor that processes information, a memory that is communicably connected to the processor, and an external interface. Various programs executable by the processor are stored in the memory, and the processor reads and executes the various programs, data, and the like stored in the memory. Accordingly, the computer functions as the control device 5. In the shown configuration, the control device 5 is disposed outside the robot 2, but the disposition of the control device 5 is not particularly limited, and for example, a part or all of the control device 5 may be accommodated in the robot 2. In addition, for example, the control device 5 may be configured to be divided into a drive control device that controls the drive of the robot 2 and the fixed camera 4 and a calibration device that performs calibration between the image coordinate system and the robot coordinate system.

### Marker 6

As described above, the marker 6 is a jig used when performing the calibration between the image coordinate system and the robot coordinate system. As shown in FIGS. 4 and 5, the marker 6 has, in a state of being disposed on the work surface 10, a cylindrical base portion 61 extending in a direction orthogonal to the work surface 10, and an annular flange portion 62 protruding in a radial direction from an outer peripheral surface of the base portion 61. The base portion 61 and the flange portion 62 are disposed concentrically. The base portion 61 has a through-hole penetrating an upper surface and a lower surface, and a recessed portion 611 that is open on the upper surface of the base portion 61 (a surface facing the positioning portion 292 of the robot 2 during calibration) is formed by the through-hole. As shown in FIG. 6, the insertion portion 296 of the positioning portion 292 is inserted into the recessed portion 611. In addition, an upper end portion of the recessed portion 611 has a truncated conical shape (tapered shape), and an inner diameter thereof gradually increases toward an upper end side. The tapered inner peripheral surface functions as a guide surface 611g that guides the insertion of the insertion portion 296. Further, below the guide surface 611g, a side surface extending along a vertical direction is formed around the guide surface 611g. In the present embodiment, the side surface is continuous with the guide surface 611g, however, the side surface and the guide surface 611g may be discontinuous, and, for example, a step, a protrusion, or another surface may be provided between the side surface and the guide surface 611g.

The flange portion 62 is an image recognition portion used to recognize an outline of the marker 6 in the image G captured by the fixed camera 4. Accordingly, the flange portion 62 protrudes sufficiently outward from the base portion 61 such that a part of the flange portion 62 is not hidden in a shadow of the base portion 61 in the image G. Further, the flange portion 62 is disposed to be biased toward a lower end side of the base portion 61 and is formed to be sufficiently thinner than the base portion 61. In particular, in the present embodiment, lower end surfaces of the base portion 61 and the flange portion 62 are flush with each other, and a lower surface of the flange portion 62 is in contact with the work surface 10. A thickness of the flange portion 62 is not particularly limited, however, for example, the thickness is preferably 1.0 mm or less. As described above, by forming the flange portion 62 to be thin and disposing the flange portion 62 to be biased toward the lower end side of the base portion 61, an upper surface of the flange portion 62 can be brought closer to the work surface 10, and a position of the marker 6 in the image G can be detected with higher accuracy.

The marker 6 as described above is made of, for example, various metal materials such as aluminum, stainless steel (SUS), and steel. By using such materials, the marker 6 has appropriate strength and weight, and, for example, deformation of the marker 6 and displacement during calibration are less likely to occur. Accordingly, calibration can be performed with high accuracy. Further, while the work surface 10 is white, the marker 6 is black, and particularly black having low gloss in which reflection of light is sufficiently suppressed. By thus setting the marker 6 to have a color different from that of the work surface 10, a position of the marker 6 in the image G can be detected with higher accuracy, thereby enabling highly accurate calibration. In particular, as in the present embodiment, by setting the work surface 10 to white and the marker 6 to black, contrast between the work surface 10 and the marker 6 is increased. Further, since the marker 6 is black having low gloss, reflection of light is sufficiently suppressed, and distortion, blurring, or the like of an outer shape (outline) of the marker 6 in the image G can be effectively suppressed. Accordingly, the above effects become more remarkable. A method of making a surface of the marker 6 black is not particularly limited and varies depending on a material of the marker 6, however, examples thereof include black chrome plating, black zinc plating, black electroless nickel plating, black anodizing treatment, and the like.

According to such a configuration, the marker 6 suitable for calibration can be obtained with a simple configuration. Although the marker 6 is described above, a configuration of the marker 6 is not particularly limited. For example, the base portion 61 may have a bottomed cylindrical shape in which an opening at a lower end side is closed. Further, the flange portion 62 may be omitted. Further, the marker 6 may be made of materials different from metal materials, such as various ceramic materials and various resin materials. Further, a planar shape of the base portion 61 and the flange portion 62 is not limited to a circular shape, and may be, for example, a quadrangular shape or a hexagonal shape. Further, the base portion 61 and the flange portion 62 may be formed as separate bodies, or may be different in color from each other.

The overall configuration of the robot system 1 is described above. Next, a calibration method of the image coordinate system and the robot coordinate system performed by the control device 5 will be described. As shown in FIG. 7, the calibration method includes a robot position acquisition step S1, a marker position acquisition step S2, a calibration step S3, a calibration accuracy confirmation step S4, and a recalibration step S5. It is assumed that various settings necessary for calibration, such as setting of various driving conditions and distortion correction of the image G, are completed before the robot position acquisition step S1. Further, as shown in FIG. 2, the calibration method is performed in a state where the tool 29 is mounted to the sixth arm 226.

### Robot Position Acquisition Step S1

In the robot position acquisition step S1, the robot arm 22 is driven, and the marker 6 is aligned with respect to the positioning portion 292 by engaging the positioning portion 292 with the marker 6, thereby acquiring a first position P1, which is a position of the positioning portion 292 in the robot coordinate system. Specifically, first, as a first step, as shown in FIG. 8, a plate-shaped jig 7 is placed on the work surface 10. Placement of the jig 7 on the work surface 10 may be performed by an operator, may be performed by the robot 2, or may be performed by a robot other than the robot 2. A thickness of the jig 7 is set to be equal to the thickness of the flange portion 62.

Next, as a second step, the control device 5 drives the robot arm 22 by a jog operation, and, as shown in FIG. 9, causes a tip end surface of the insertion portion 296 to abut an upper surface of the jig 7 in an orientation in which the positioning portion 292 is oriented downward in a vertical direction (an orientation in which a center axis J1 coincides with the vertical direction; hereinafter also referred to as an “insertion orientation”). Then, the control device 5 determines a position of the robot arm 22 at which the insertion portion 296 abuts the jig 7 as a lower limit position Q in height.

Next, as a third step, a plurality of markers 6 are placed on the work surface 10. Each of the markers 6 is configured to slide with respect to the work surface 10. The number of markers 6 is not particularly limited as long as the number is two or more, however, in the present embodiment, the number is nine. As the number of markers 6 increases, higher accuracy calibration can be achieved, while time required for calibration becomes longer. In this respect, by setting the number of markers 6 to about nine, a balance between these advantages and disadvantages is improved, thereby enabling highly accurate calibration while keeping the time required for calibration at a reasonable level.

Further, at this time, as shown in FIG. 10, nine markers 6 are disposed such that one marker 6 is positioned in each of nine regions obtained by dividing a field of view R of the fixed camera 4 into a 3×3 matrix. With such a disposition, the markers 6 can be distributed over the entire image G and disposed without bias. Accordingly, higher accuracy calibration can be achieved. However, disposition of the respective markers 6 is not particularly limited. Hereinafter, for convenience of description, the nine markers 6 may be distinguished as markers 6A, 6B, 6C, 6D, 6E, 6F, 6G, 6H, and 6I.

Next, as a fourth step, the robot arm 22 is driven by a jog operation, and, as shown in FIG. 11, the positioning portion 292 is positioned directly above the marker 6A in the insertion orientation. At this stage, since the position of the marker 6A is unknown, this step can be easily performed by an operator by driving the robot arm 22 by a jog operation while visually checking the marker 6A. In particular, since the marker 6 has a tubular shape, the marker 6 is easy to visually check, and this step can be performed even more easily. Next, as a fifth step, the robot arm 22 is driven by a jog operation, and the positioning portion 292 is lowered until the robot arm 22 reaches the lower limit position Q, thereby inserting the insertion portion 296 into the recessed portion 611 of the marker 6A. As a result, the insertion portion 296 and the marker 6A are engaged with each other.

At this time, as shown in FIG. 12, the guide surfaces 296g and 611g slide against each other, whereby the marker 6A moves (slides) on the work surface 10 such that a center axis J2 of the marker 6A approaches the center axis J1 of the insertion portion 296, and eventually the center axes J1 and J2 coincide with each other, so that the marker 6A is aligned with the insertion portion 296. As described above, according to the configuration in which the insertion portion 296 is inserted into the recessed portion 611, the marker 6A can be easily aligned with the insertion portion 296. Further, when the robot arm 22 is stopped at the lower limit position Q, excessive stress is less likely to be applied to the marker 6 and the positioning portion 292 in this step.

Here, as shown in FIG. 12, in the fourth step, it is not necessary to cause the center axis J1 of the positioning portion 292 to coincide with the center axis J2 of the marker 6A, and the center axis J1 may be slightly displaced from the center axis J2. This is because, even when the center axis J1 is displaced from the center axis J2, in the fifth step the guide surfaces 296g and 611g slide against each other, whereby the marker 6A moves in a following manner and is automatically brought into an aligned state. As described above, according to the present embodiment, since high positioning accuracy is not required in the fourth step, the fourth step can be performed in a shorter time. Further, even an operator with a low skill level can easily perform the fourth step. Further, since impact (stress) generated when the insertion portion 296 is inserted into the marker 6A can be effectively absorbed and alleviated by contraction of the coil spring 295, deformation, breakage, or the like of the marker 6A and the positioning portion 292 can also be effectively suppressed. In the fifth step, after the marker 6A is aligned with the insertion portion 296, the insertion portion 296 is further lowered to the lower limit position Q in height. At this time, since a side surface located above the guide surface 296g and a side surface located below the guide surface 611g both extend along a vertical direction, the side surfaces are less likely to interfere with each other during lowering. As a result, displacement between the two is less likely to occur, and the aligned state is maintained.

Next, as a sixth step, the control device 5 acquires a first position P1, which is a position of the positioning portion 292 in the robot coordinate system in a state in which the marker 6A is aligned with respect to the insertion portion 296, that is, in a state in which the insertion portion 296 and the marker 6A are engaged with each other. In the present embodiment, the first position P1 is acquired as a position of the TCP. In the present embodiment, a second position P2, which is a position in the image coordinate system, is a position of the center of the marker 6, and is acquired based on an outline of the flange portion 62 captured from above. Therefore, it is desirable that a height of the first position P1 is acquired to be equal to the height of the upper surface of the flange portion 62, that is, the lower limit position Q of the height. Accordingly, calibration accuracy can be improved.

The control device 5 performs the fourth step to the sixth step as described above in the same manner for the other markers 6B to 6I. As a result, a total of nine first positions P1 are acquired, including: the first position P1 in a state in which the insertion portion 296 and the marker 6A are engaged with each other; the first position P1 in a state in which the insertion portion 296 and the marker 6B are engaged with each other; the first position P1 in a state in which the insertion portion 296 and the marker 6C are engaged with each other; the first position P1 in a state in which the insertion portion 296 and the marker 6D are engaged with each other; the first position P1 in a state in which the insertion portion 296 and the marker 6E are engaged with each other; the first position P1 in a state in which the insertion portion 296 and the marker 6F are engaged with each other; the first position P1 in a state in which the insertion portion 296 and the marker 6G are engaged with each other; the first position P1 in a state in which the insertion portion 296 and the marker 6H are engaged with each other; and the first position P1 in a state in which the insertion portion 296 and the marker 6I are engaged with each other.

As described above, the robot position acquisition step S1 is completed. However, the robot position acquisition step S1 is not particularly limited.

### Marker Position Acquisition Step S2

In the marker position acquisition step S2, the fixed camera 4 is used to image the respective markers 6 after alignment, and based on the obtained image G2, second positions P2, which are positions of the respective markers 6A to 6I in the image coordinate system, are acquired. Specifically, first, as a seventh step, the control device 5 drives the robot arm 22 and retracts the robot arm 22 outside the field of view R of the fixed camera 4. Next, as an eighth step, the control device 5 images the markers 6A to 6I on the work surface 10 collectively using the fixed camera 4, and acquires an image G2 in which all of the markers 6A to 6I are shown, as shown in FIG. 13. Next, as a ninth step, the control device 5 processes the image G2 using a predetermined image processing technique to recognize the respective markers 6A to 6I in the image G2, and detects second positions P2, which are positions of the respective markers 6A to 6I in the image coordinate system. In the present embodiment, the second positions P2 are acquired as positions of centers of the markers 6.

According to such a method, since the second positions P2 of the respective markers 6A to 6I can be acquired from a single image G2, the marker position acquisition step S2 can be performed in a short time. Further, as described above, since the marker 6 includes the flange portion 62, an outline of the marker 6 can be recognized with high accuracy. Further, since the marker 6 is black and has high contrast with the white work surface 10, the outline of the marker 6 can be recognized with high accuracy. Accordingly, in the marker position acquisition step S2, the second positions P2 of the respective markers 6A to 6I can be detected with high accuracy.

As described above, the marker position acquisition step S2 is completed. However, the marker position acquisition step S2 is not particularly limited. For example, each time alignment of one marker 6 is completed, the second position P2 of that marker 6 may be acquired. That is, after alignment of one marker 6 is completed, a step of detecting the second position P2 of that marker 6 from the image G2 obtained by the fixed camera 4 may be repeatedly performed for each of the markers 6A to 6I, thereby acquiring the second positions P2 of the respective markers 6A to 6I.

### Calibration Step S3

In the calibration step S3, as a tenth step, the control device 5 performs calibration to associate the robot coordinate system with the image coordinate system based on the first positions P1 acquired in the robot position acquisition step S1 and the second positions P2 acquired in the marker position acquisition step S2. Specifically, as a result of the robot position acquisition step S1 and the marker position acquisition step S2, the control device 5 acquires nine sets of the [first position/second position], that is, a [first position/second position] for the marker 6A, a [first position/second position] for the marker 6B, a [first position/second position] for the marker 6C, a [first position/second position] for the marker 6D, a [first position/second position] for the marker 6E, a [first position/second position] for the marker 6F, a [first position/second position] for the marker 6G, a [first position/second position] for the marker 6H, and a [first position/second position] for the marker 6I. Therefore, in this step, the control device 5 derives a coordinate conversion formula for converting image coordinates into robot coordinates based on these nine sets of [first position/second position]. As a result, calibration between the image coordinate system and the robot coordinate system is completed.

### Calibration Accuracy Confirmation Step S4

In the calibration accuracy confirmation step S4, accuracy of the calibration performed in the calibration step S3 is confirmed. Specifically, first, as an eleventh step, the control device 5 disposes a plurality of markers 6 on the work surface 10. The number of markers 6 is not particularly limited as long as the number is one or more; however, in the present embodiment, the number is nine. Hereinafter, for convenience of description, the nine markers 6 may be distinguished as markers 6A, 6B, 6C, 6D, 6E, 6F, 6G, 6H, and 6I.

Next, as a twelfth step, the control device 5 collectively images all the markers 6A to 6I on the work surface 10 using the fixed camera 4, and acquires an image G3 in which all the markers 6A to 6I are shown, as shown in FIG. 14. Next, as a thirteenth step, the control device 5 detects positions of the respective markers 6A to 6I in the robot coordinate system from the image G3 using the result of the calibration performed in the calibration step S3.

Next, as a fourteenth step, the control device 5 drives the robot arm 22 and, as shown in FIG. 15, positions the positioning portion 292 in the insertion orientation directly above a position of the marker 6A in the robot coordinate system. Since the position of the marker 6A is detected based on the calibration result in the thirteenth step, it is unlikely that the detected position is largely displaced from an actual position of the marker 6, and an amount of displacement sufficiently falls within a range in which the functions of the guide surfaces 296g and 611g described above are exhibited. Next, as a fifteenth step, the control device 5 drives the robot arm 22 and lowers the positioning portion 292 to insert the insertion portion 296 into the marker 6A, as shown in FIG. 16. At this time, as accuracy of the calibration performed in the calibration step S3 becomes worse, the center axis J1 of the positioning portion 292 deviates more from the center axis J2 of the marker 6, and thus the marker 6 is displaced to a greater extent.

The control device 5 performs the fourteenth step and the fifteenth step as described above in the same manner for the other markers 6B to 6I. Next, as a sixteenth step, the control device 5 collectively images the markers 6A to 6I on the work surface 10 using the fixed camera 4, and acquires an image G4 in which all the markers 6A to 6I are shown, as shown in FIG. 17. Next, as a seventeenth step, the control device 5 compares the image G3 showing the markers 6A to 6I before alignment with the image G4 showing the markers 6A to 6I after alignment, and confirms accuracy of the calibration performed in the calibration step S3 based on degrees of displacement of the respective markers 6A to 6I. Then, when the calibration accuracy does not satisfy a predetermined condition, a subsequent recalibration step S5 is performed. On the other hand, when the calibration accuracy satisfies the predetermined condition, the recalibration step S5 need not be performed.

### Recalibration Step S5

In the recalibration step S5, the calibration between the robot coordinate system and the image coordinate system is performed again. Specifically, first, various driving conditions are set and distortion correction of images obtained by the fixed camera 4 is performed. Next, as an eighteenth step, a plurality of markers 6 are disposed on the work surface 10. The number of markers 6 is not particularly limited as long as the number is two or more; however, in the present embodiment, the number is nine. Hereinafter, for convenience of description, the nine markers 6 may be distinguished as markers 6A, 6B, 6C, 6D, 6E, 6F, 6G, 6H, and 6I.

Next, as a nineteenth step, the control device 5 collectively images the markers 6A to 6I on the work surface 10 using the fixed camera 4, and acquires an image G5 in which all of the markers 6A to 6I are shown, as shown in FIG. 18. Next, as a twentieth step, the control device 5 detects positions of the respective markers 6A to 6I in the robot coordinate system from the image G5 using a result of the latest calibration.

Next, as a twenty-first step, the control device 5 drives the robot arm 22 and, as shown in FIG. 19, positions the positioning portion 292 in the insertion orientation directly above a position of the marker 6A in the robot coordinate system. Next, as a twenty-second step, the control device 5 drives the robot arm 22 and lowers the positioning portion 292 to insert the insertion portion 296 into the marker 6A, as shown in FIG. 20. It is unlikely that the position is largely displaced from an actual position of the marker 6, and an amount of displacement sufficiently falls within a range in which the functions of the guide surfaces 296g and 611g described above are exhibited. Next, as a twenty-third step, the control device 5 acquires a first position P1, which is a position of the positioning portion 292 in the robot coordinate system in a state in which the insertion portion 296 is inserted into the marker 6A.

The control device 5 performs the twenty-first step to the twenty-third step as described above in the same manner for the other markers 6B to 6I. Next, as a twenty-fourth step, the control device 5 collectively images the markers 6A to 6I on the work surface 10 using the fixed camera 4, and acquires an image G6 in which all of the markers 6A to 6I are shown, as shown in FIG. 21. Next, as a twenty-fifth step, the control device 5 processes the image G6 using a predetermined image processing technique to recognize the respective markers 6A to 6I in the image G6, and detects second positions P2, which are positions of the respective markers 6A to 6I in the image coordinate system. Next, as a twenty-sixth step, the control device 5 performs calibration to associate the robot coordinate system with the image coordinate system based on the first positions P1 and the second positions P2 obtained as described above.

The calibration method between the image coordinate system and the robot coordinate system is described above. According to such a calibration method, since positioning work based on visual observation as in the related art is not required, variation attributable to an operator does not occur. Accordingly, deterioration and variation of calibration accuracy can be effectively suppressed. Further, since calibration can be performed without using a force sensor such as a force-sensitive sensor, the apparatus configuration can be simplified. Further, since the work surface 10 is not directly touched by the tool 29, such as in touch-up operations, damage to the work surface 10 can also be effectively suppressed.

The robot system 1 is described above. As described above, the robot system 1 includes the robot 2 having the robot arm 22 and the positioning portion 292 disposed at the tip end portion of the robot arm 22, the marker 6 that is disposed on the work surface 10, is configured to slide with respect to the work surface 10, and is aligned with the positioning portion 292 by engaging with the positioning portion 292, the fixed camera 4 as the imaging portion that captures an image of the marker 6, and the control device 5 as the control portion that performs calibration between the robot coordinate system set in the robot 2 and the image coordinate system set in the fixed camera 4. Then, the control device 5 drives the robot arm 22 and engages the positioning portion 292 with the marker 6, thereby aligning the marker 6 with the positioning portion 292, acquires a first position P1 that is a position of the positioning portion 292 in the robot coordinate system, images the marker 6 after alignment using the fixed camera 4, acquires, based on the obtained image G2, a second position P2 that is a position of the marker 6 in the image coordinate system, and performs calibration between the robot coordinate system and the image coordinate system based on the first position P1 and the second position P2. According to such a configuration, since positioning work based on visual observation as in the related art is not required, variation attributable to an operator does not occur. Accordingly, deterioration and variation of calibration accuracy can be effectively suppressed.

Further, as described above, the marker 6 has the base portion 61 that extends in a direction orthogonal to the work surface 10 and includes the recessed portion 611 formed in an upper surface that is a surface facing the positioning portion 292. On the other hand, the positioning portion 292 has the insertion portion 296 that is inserted into the recessed portion 611. By inserting the insertion portion 296 into the recessed portion 611, the marker 6 is aligned with respect to the positioning portion 292. According to such a configuration, alignment of the marker 6 can be easily performed.

Further, as described above, at least one of the base portion 61 and the insertion portion 296 (both in the present embodiment) has guide surfaces 611g and 296g that guide the other such that center axes J1 and J2 thereof coincide with each other. According to such a configuration, high positioning accuracy is not required in the robot position acquisition step S1, and therefore alignment of the marker 6 can be easily performed.

Further, as described above, the marker 6 has an annular flange portion 62 that protrudes outward from the base portion 61 in a plan view of the work surface 10. According to such a configuration, the position of the marker 6 on the image G2 can be detected with high accuracy.

Further, as described above, the flange portion 62 is thinner than the base portion 61, protrudes from an end portion of the base portion 61 on the work surface 10 side, and is in contact with the work surface 10. According to such a configuration, an upper surface of the flange portion 62 can be brought closer to the work surface 10, and the position of the marker 6 on the image G2 can be detected with higher accuracy.

Further, as described above, the marker 6 has a color different from that of the work surface 10. According to such a configuration, the position of the marker 6 on the image G2 can be detected with high accuracy.

As described above, the marker 6 is a marker used for calibration between the robot coordinate system set in the robot 2 having the robot arm 22 and the positioning portion 292 disposed at a tip end portion of the robot arm 22, and the image coordinate system set in the fixed camera 4 that images the work surface 10, the marker 6 being disposed on the work surface 10 and being configured to slide with respect to the work surface 10, and including a base portion 61 that extends in a direction orthogonal to the work surface 10 and includes the recessed portion 611 formed in a surface facing the positioning portion 292, and the annular flange portion 62 that protrudes outward from the base portion 61 in a plan view of the work surface 10. The marker 6 is aligned with respect to the positioning portion 292 by insertion of the positioning portion 292 into the recessed portion 611. According to such a configuration, the marker 6 suitable for calibration can be obtained with a simple configuration.

As described above, the calibration method is a calibration method for performing calibration between the robot coordinate system set in the robot 2 and the image coordinate system set in the fixed camera 4, in the robot system 1 including the robot 2 having the robot arm 22 and the positioning portion 292 disposed at the tip end portion of the robot arm 22, the marker 6 that is disposed on the work surface 10, is configured to slide with respect to the work surface 10, and is aligned with respect to the positioning portion 292 by engagement with the positioning portion 292, and the fixed camera 4 as the imaging portion that images the marker 6, the calibration method including: the robot position acquisition step S1 of driving the robot arm 22, engaging the positioning portion 292 with the marker 6 to align the marker 6 with the positioning portion 292, and acquiring the first position P1 that is the position of the positioning portion 292 in the robot coordinate system; the marker position acquisition step S2 of imaging the marker 6 after the alignment using the fixed camera 4 and acquiring, based on the obtained image G2, the second position P2 that is the position of the marker 6 in the image coordinate system; and the calibration step S3 of performing calibration between the robot coordinate system and the image coordinate system based on the first position P1 and the second position P2. According to such a configuration, since positioning work based on visual observation as in the related art is not required, variation attributable to an operator does not occur. Accordingly, deterioration and variation of calibration accuracy can be effectively suppressed.

### Second Embodiment

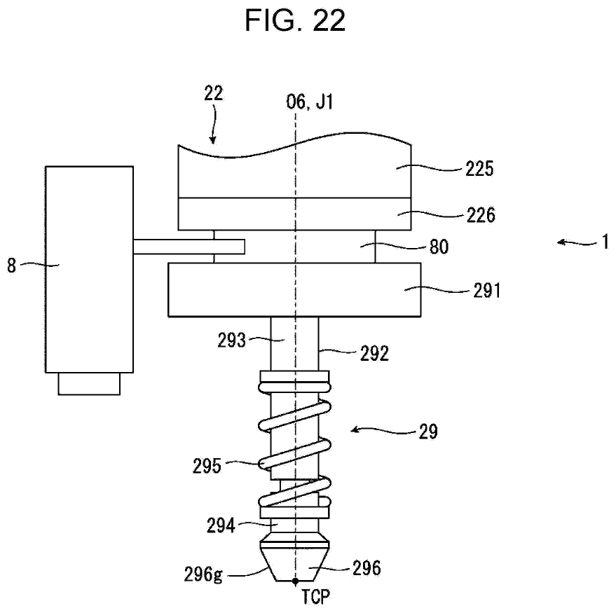

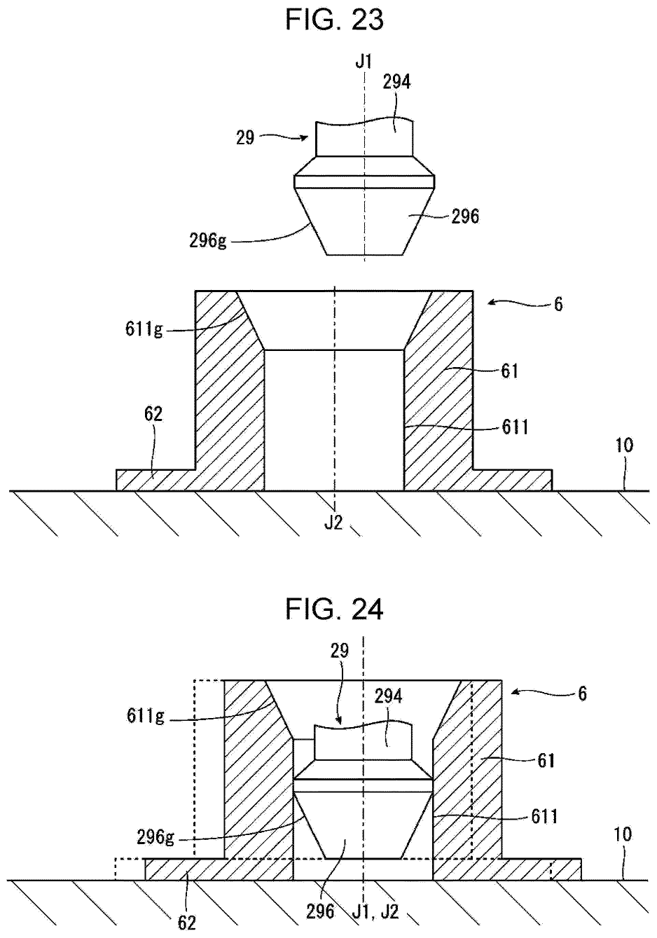

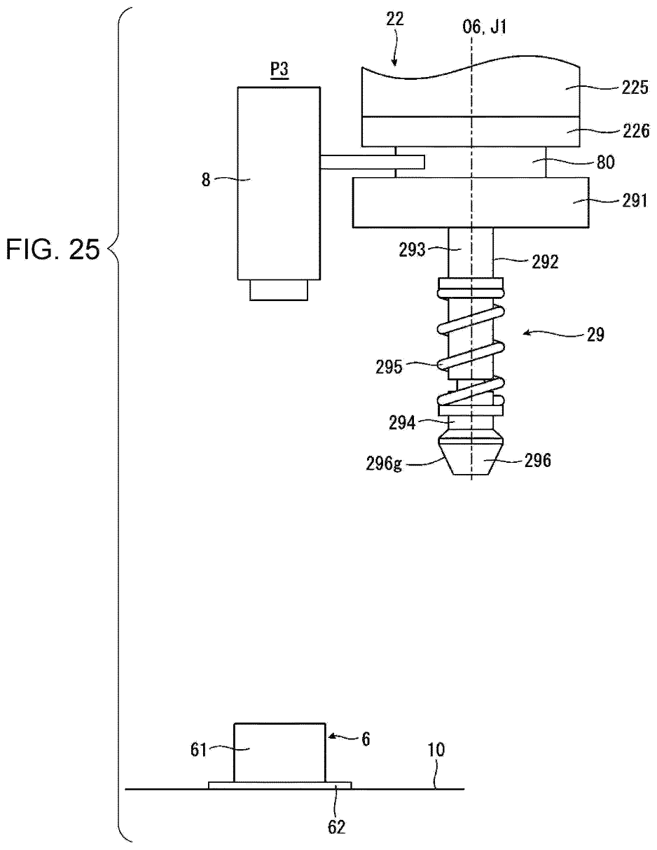

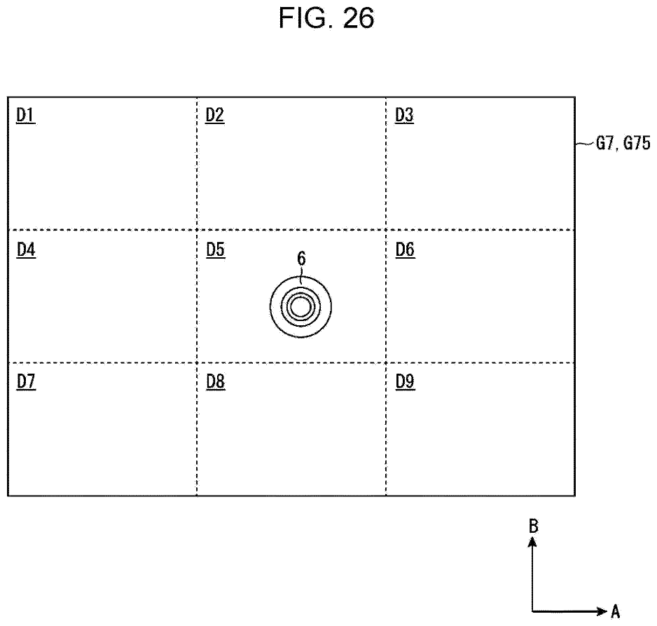

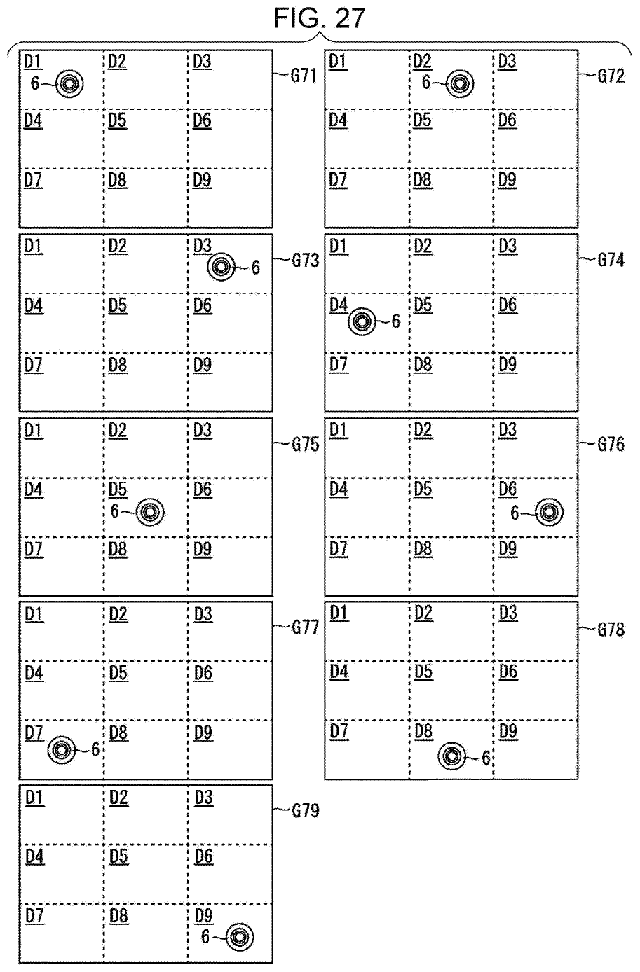

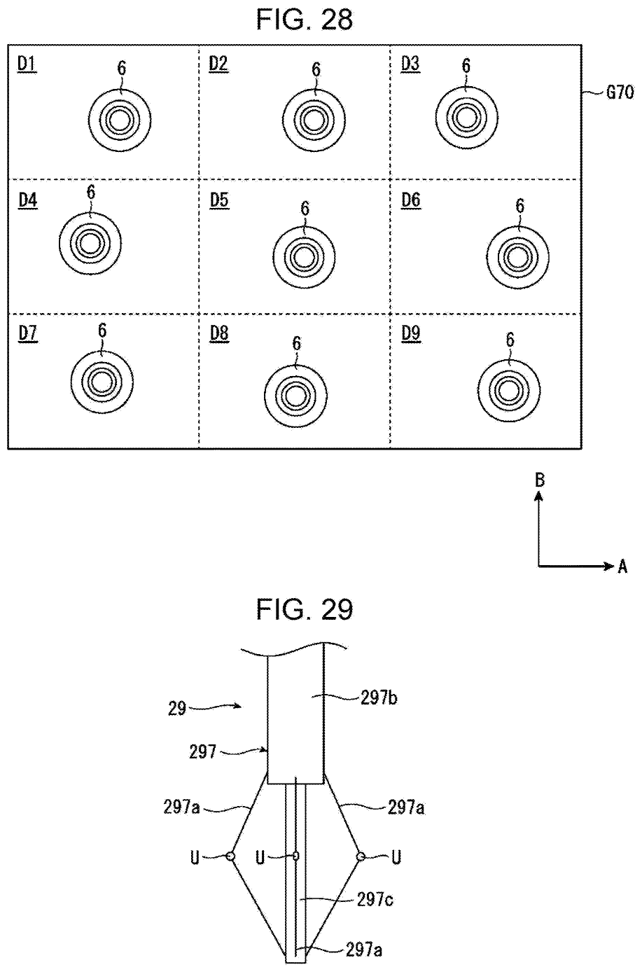

FIG. 22 is a diagram showing a configuration of a robot system according to a second embodiment. FIG. 23 is a diagram showing a state in which a positioning portion is positioned directly above a marker. FIG. 24 is a diagram showing a state in which the positioning portion is inserted into the marker. FIG. 25 is a diagram showing a state in which a robot camera is positioned at an imaging position. FIGS. 26 and 27 are diagrams showing examples of images obtained by capturing the markers after alignment. FIG. 28 is a diagram showing an image obtained by compositing the nine images shown in FIG. 27.

The robot system 1 of the present embodiment is the same as that of the above-described first embodiment except that a configuration of the imaging portion is different. In the following description, with respect to the present embodiment, description will be given focusing mainly on differences from the above-described first embodiment, and description of the same matters will be omitted. Further, in each drawing of the present embodiment, components that are the same as those of the above-described embodiment are denoted by the same reference numerals.

In the robot system 1 of the present embodiment, the fixed camera 4 is omitted. Instead, as shown in FIG. 22, the robot system 1 includes the robot camera 8 as an imaging portion that is mounted on the sixth arm 226 via an adapter 80. The tool 29 is mounted on the adapter 80. When work is performed on the workpiece W, the tool 29 may be removed from the adapter 80, and a working tool 24 may be mounted on the adapter 80. The robot camera 8 images a tip end side of the tool 29. Further, the robot camera 8 is disposed offset with respect to the sixth rotation axis O6, and an optical axis of the robot camera 8 extends along the sixth rotation axis O6. Such a robot camera 8 is a digital camera including a lens and an area image sensor. Further, an image coordinate system is set in the robot camera 8.

Although the robot camera 8 is described above, the configuration and the disposition of the robot camera 8 are not particularly limited. For example, the robot camera 8 may be disposed at a location other than the sixth arm 226 of the robot arm 22, such as the fifth arm 225.

Also in such a robot system 1, first, the calibration between the image coordinate system and the robot coordinate system is performed using the marker 6, and then, the drive of the robot 2 is controlled based on the image captured by the robot camera 8, and the predetermined work is performed on the workpiece W.

The overall configuration of the robot system 1 is described above. Next, a calibration method of the image coordinate system and the robot coordinate system performed by the control device 5 will be described. As in the first embodiment described above, the calibration method includes the robot position acquisition step S1, the marker position acquisition step S2, the calibration step S3, the calibration accuracy confirmation step S4, and the recalibration step S5.

### Robot Position Acquisition Step S1

In the robot position acquisition step S1, first, as a first step, a lower limit position Q is determined using the jig 7 in the same manner as in the above-described first embodiment. Next, as a second step, an operator teaches, to the control device 5, an imaging position P3 that is a position of the robot camera 8 in the robot coordinate system when imaging the marker 6. Next, as a third step, one marker 6 is placed on the work surface 10. At this time, it is preferable that the marker 6 is disposed to be positioned as close as possible to a central portion of a field of view R of the robot camera 8 at the imaging position P3.

Next, as a fourth step, the control device 5 drives the robot arm 22 by a jog operation and, as shown in FIG. 23, positions the positioning portion 292 directly above the marker 6 in an insertion orientation. Next, as a fifth step, the control device 5 drives the robot arm 22 by a jog operation and, as shown in FIG. 24, lowers the positioning portion 292 until the robot arm 22 reaches the lower limit position Q, thereby inserting the insertion portion 296 into the marker 6. As a result, the insertion portion 296 and the marker 6 are engaged with each other. Next, as a sixth step, a first position P1 that is a position of the positioning portion 292 in the robot coordinate system in a state in which the insertion portion 296 and the marker 6 are engaged with each other is acquired.

Next, as a seventh step, the control device 5 drives the robot arm 22 and, as shown in FIG. 25, positions the robot camera 8 at the imaging position P3 while maintaining the positioning portion 292 in the insertion orientation. Then, as an eighth step, the control device 5 images the marker 6 on the work surface 10 using the robot camera 8 and acquires an image G7 in which the marker 6 is captured, as shown in FIG. 26. In the image G7, among nine regions D1 to D9 obtained by dividing the image G7 into a 3×3 matrix, the marker 6 is positioned within a region D5 positioned at a central portion. Hereinafter, the image G7 is also referred to as an image G75.

Next, as a ninth step, the control device 5 drives the robot arm 22 by a jog operation and moves the robot camera 8 in a horizontal direction while maintaining a Z-axis coordinate of the imaging position P3 and an orientation of the robot camera 8, such that the marker 6 is positioned within a region D1. Then, as a tenth step, the control device 5 images the marker 6 on the work surface 10 using the robot camera 8 and acquires the first position P1 of the positioning portion 292 at the time of imaging. By maintaining the Z-axis coordinate constant, a separation distance between the robot camera 8 and the work surface 10 is maintained, and an imaging range (a range captured in an image) can be made the same as that of the image G7. However, as long as the Z-axis coordinate at the time of imaging is the same as the Z-axis coordinate of the imaging position P3, the robot camera 8 may move up and down during movement. Similarly, as long as the orientation at the time of imaging is the same as the orientation at the imaging position P3, the orientation of the robot camera 8 may change during movement.

The control device 5 performs such a ninth step and a tenth step for the other regions D2 to D4 and D6 to D9 in the same manner. As a result, as shown in FIG. 27, an image G71 in which the marker 6 is positioned in the region D1, an image G72 in which the marker 6 is positioned in the region D2, an image G73 in which the marker 6 is positioned in the region D3, an image G74 in which the marker 6 is positioned in the region D4, an image G75 in which the marker 6 is positioned in the region D5, an image G76 in which the marker 6 is positioned in the region D6, an image G77 in which the marker 6 is positioned in the region D7, an image G78 in which the marker 6 is positioned in the region D8, and an image G79 in which the marker 6 is positioned in the region D9 are obtained. Further, the first position P1 of the positioning portion 292 when the image G71 is captured, the first position P1 of the positioning portion 292 when the image G72 is captured, the first position P1 of the positioning portion 292 when the image G73 is captured, the first position P1 of the positioning portion 292 when the image G74 is captured, the first position P1 of the positioning portion 292 when the image G75 is captured, the first position P1 of the positioning portion 292 when the image G76 is captured, the first position P1 of the positioning portion 292 when the image G77 is captured, the first position P1 of the positioning portion 292 when the image G78 is captured, and the first position P1 of the positioning portion 292 when the image G79 is captured are obtained.

As described above, the robot position acquisition step S1 is completed. However, the robot position acquisition step S1 is not particularly limited.

### Marker Position Acquisition Step S2

In the marker position acquisition step S2, first, as an eleventh step, the control device 5 composites nine images G71 to G79 to generate, as shown in FIG. 28, one image G70 in which the marker 6 is positioned in each of regions D1 to D9. Next, as a twelfth step, the control device 5 processes the image G70 using a predetermined image processing technique, recognizes each marker 6 in the image G70, and acquires a second position P2 that is a position of each marker 6 in the image coordinate system.

As described above, the marker position acquisition step S2 is completed. However, the marker position acquisition step S2 is not particularly limited. For example, the second position P2 may be acquired from each of the images G71 to G79 without compositing the image G70.

### Calibration Step S3

In the calibration step S3, as a thirteenth step, the control device 5 performs calibration for associating the robot coordinate system with the image coordinate system based on the first position P1 acquired in the robot position acquisition step S1 and the second position P2 acquired in the marker position acquisition step S2.

### Calibration Accuracy Confirmation Step S4

The calibration accuracy confirmation step S4 is the same as that of the above-described first embodiment, except that a step of positioning the robot camera 8 at the imaging position P3 when the images G3 and G4 are acquired is added. Therefore, a detailed description is omitted.

### Recalibration Step S5

The recalibration step S5 is the same as that of the above-described first embodiment, except that a step of positioning the robot camera 8 at the imaging position P3 is added when acquiring the images G5 and G6. Therefore, a detailed description is omitted.

Even in the second embodiment, it is possible to exhibit the same effect as that of the above-described first embodiment.

In the present embodiment, the nine images G71 to G79 are acquired, but the number of images is not limited thereto, and at least two or more images may be acquired. That is, as long as at least two first positions and at least two second positions corresponding to the respective first positions can be acquired, the number of images is not particularly limited. Further, positions of the marker 6 in the images are also not particularly limited as long as the positions differ from each other among the images, and for example, two or more markers 6 may be positioned within any one of the regions D1 to D9. In addition, the number, disposition, shape, and the like of the regions are not particularly limited, and for example, the regions may be a 2×2 matrix or a 4×4 matrix.

### Third Embodiment

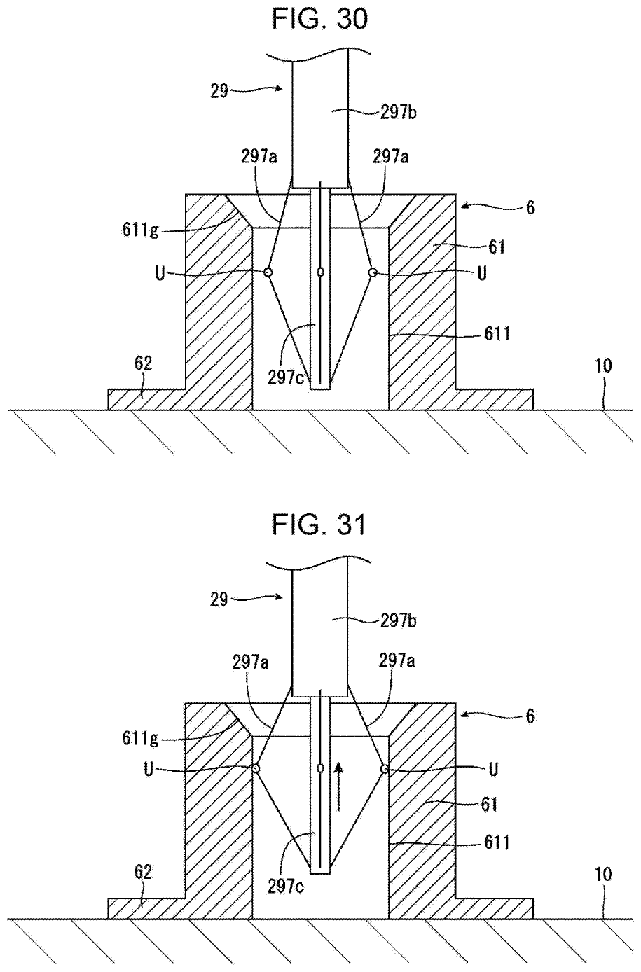

FIG. 29 is a diagram showing a positioning portion of a robot system according to a third embodiment. FIGS. 30 and 31 are diagrams for describing a method of using the positioning portion, respectively.

The robot system 1 of the present embodiment is the same as that of the above-described first embodiment except that a configuration of the positioning portion 292 is different. In the following description, with respect to the present embodiment, description will be given focusing mainly on differences from the above-described first embodiment, and description of the same matters will be omitted. Further, in each drawing of the present embodiment, components that are the same as those of the above-described embodiment are denoted by the same reference numerals.

As shown in FIG. 29, the positioning portion 292 includes an expanding portion 297 disposed at a tip end portion thereof. The expanding portion 297 includes four arms 297a each having a joint U in a middle portion, and upper end portions of the four arms 297a are rotatably coupled to an outer cylinder 297b. The four arms 297a are arranged evenly in a circumferential direction. Further, a rod-shaped operation portion 297c is inserted into the outer cylinder 297b, and lower end portions of the four arms 297a are rotatably coupled to the operation portion 297c. Further, although not shown, the expanding portion 297 includes a motor as a drive source for moving the operation portion 297c up and down. With such a configuration, when the motor moves the operation portion 297c upward relative to the outer cylinder 297b, the joints U of the respective arms 297a bend to expand, and when the motor moves the operation portion 297c downward relative to the outer cylinder 297b, the joints U of the respective arms 297a extend to contract.

When alignment of the marker 6 is performed using such a positioning portion 292, first, as shown in FIG. 30, the expanding portion 297 is inserted into the recessed portion 611 of the marker 6 in a state in which the expanding portion 297 is contracted. Next, as shown in FIG. 31, the expanding portion 297 is expanded, and the joints U of the respective arms 297a are caused to abut an inner peripheral surface of the recessed portion 611. Accordingly, the marker 6 is aligned with respect to the positioning portion 292. Then, after the alignment, the expanding portion 297 is contracted, and thereafter the expanding portion 297 is removed from the recessed portion 611. Also with such a configuration, alignment of the marker 6 with the positioning portion 292 can be easily performed.

As described above, in the robot system 1 of the present embodiment, the marker 6 includes the base portion 61 that extends in a direction orthogonal to the work surface 10 and includes the recessed portion 611 that opens on an upper surface that is a surface facing the positioning portion 292. Further, the positioning portion 292 includes the expanding portion 297 that expands in the recessed portion 611 and abuts on the inner peripheral surface of the recessed portion 611. Then, by expanding the expanding portion 297 in a state in which the expanding portion 297 is inserted into the recessed portion 611, the marker 6 is aligned with respect to the positioning portion 292. With such a configuration, alignment of the marker 6 with the positioning portion 292 can be easily performed.

Even in the third embodiment, it is possible to exhibit the same effect as that of the above-described first embodiment. However, the configuration of the expanding portion 297 is not particularly limited. For example, the number of the arms 297a is not limited to four, and may be three or fewer, or five or more. Further, the expanding portion 297 may be configured as, for example, a balloon that expands and contracts by supply and discharge of a gas such as air. Further, the expanding portion 297 may be expanded by bringing the operation portion 297c into abutment with the work surface 10 through a lowering movement of the robot.

### Fourth Embodiment

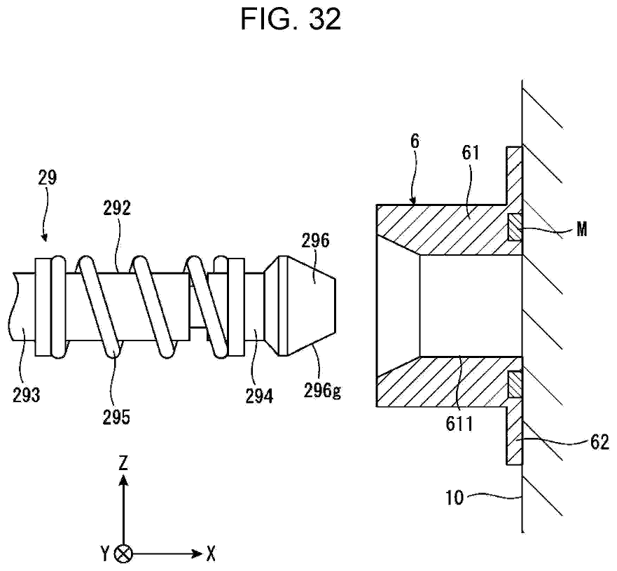

FIG. 32 is a diagram showing a work surface of a robot system according to a fourth embodiment.

The robot system 1 of the present embodiment is the same as the above-described first embodiment, except that a direction of the work surface 10 is different and that the marker 6 can be magnetically attracted to the work surface 10. In the following description, with respect to the present embodiment, description will be given focusing mainly on differences from the above-described first embodiment, and description of the same matters will be omitted. Further, in the drawings of the present embodiment, components that are the same as those of the above-described embodiment are denoted by the same reference numerals.

As shown in FIG. 32, the work surface 10 is inclined with respect to a horizontal plane. In particular, in the present embodiment, the work surface 10 is a vertical surface extending along the Z-axis. Further, the marker 6 has a magnet M and can be magnetically attracted to the work surface 10. As a result, the marker 6 can be retained on the work surface 10. The magnetic attraction force of the marker 6 is preferably as weak as possible as long as the marker 6 can be retained on the work surface 10. As a result, during alignment by the positioning portion 292, the marker 6 can more easily follow and move along the work surface 10.

As described above, the marker 6 can be magnetically attracted to the work surface 10. According to such a configuration, even when the work surface 10 is inclined with respect to the horizontal plane, the marker 6 can be disposed on the work surface 10, and calibration can be performed.

Even in the fourth embodiment, it is possible to exhibit the same effect as that of the above-described first embodiment. However, the configuration of the marker 6 is not particularly limited, and the entire marker 6 may be formed of the magnet M.

As described above, although the robot system, the marker, and the calibration method of the present disclosure have been described based on the shown embodiments, the present disclosure is not limited thereto, and the configurations of the respective portions may be replaced with any configurations or any steps having similar functions. Further, any other configurations or any other steps may be added to the present disclosure.

Further, in the above-described embodiments, a configuration is adopted in which the convex positioning portion 292 is inserted into the concave marker 6; however, the present disclosure is not limited thereto. For example, a configuration may be adopted in which the concave and convex shapes are reversed, that is, the concave positioning portion 292 covers the convex marker 6. Further, in the above-described embodiments, each of the positioning portion 292 and the marker 6 has the guide surfaces 296g and 611g; however, the present disclosure is not limited thereto, and one of the guide surfaces 296g and 611g may be omitted.

1. A robot system comprising:
a robot including a robot arm and a positioning portion disposed at a tip end portion of the robot arm;
a marker that is disposed on a work surface, is configured to slide with respect to the work surface, and is configured to engage with the positioning portion;
an imaging portion configured to image the marker; and
a control device configured to perform calibration between a robot coordinate system set in the robot and an image coordinate system set in the imaging device, wherein
the control device
drives the robot arm and engages the positioning portion with the marker, thereby aligning the marker with the positioning portion, and acquires a first position that is a position of the positioning portion in the robot coordinate system,
images the marker after the alignment using the imaging device, and acquires a second position that is a position of the marker in the image coordinate system, based on an obtained image, and
performs calibration between the robot coordinate system and the image coordinate system based on the first position and the second position.

2. The robot system according to claim 1, wherein
the marker includes a base portion that extends in a direction orthogonal to the work surface and has a recessed portion formed in a surface facing the positioning portion,
the positioning portion includes an insertion portion inserted into the recessed portion, and
the marker is aligned with the positioning portion by inserting the insertion portion into the recessed portion.

3. The robot system according to claim 1, wherein
the marker includes a base portion that extends in a direction orthogonal to the work surface and has a recessed portion that is open on a surface facing the positioning portion,
the positioning portion has an expanding portion that expands in the recessed portion and abuts on an inner peripheral surface of the recessed portion, and
the marker is aligned with the positioning portion by expanding the expanding portion in a state in which the expanding portion is inserted into the recessed portion.

4. The robot system according to claim 2, wherein
at least one of the base portion and the insertion portion has a guide surface that guides another one of the base portion and the insertion portion so that center axes of the base portion and the insertion portion coincide with each other.

5. The robot system according to claim 2, wherein
the marker has an annular flange portion protruding outward from the base portion in a plan view of the work surface.

6. The robot system according to claim 5, wherein
the flange portion is thinner than the base portion, protrudes from an end portion of the base portion on a work surface side, and is in contact with the work surface.

7. The robot system according to claim 1, wherein
the marker is configured to be magnetically attracted to the work surface.

8. The robot system according to claim 1, wherein
the marker has a color different from a color of the work surface.

9. A marker used for calibration between a robot coordinate system set in a robot having a robot arm and a positioning portion disposed at a tip end portion of the robot arm, and an image coordinate system set in an imaging device that images a work surface,
the marker being disposed on the work surface and being configured to slide with respect to the work surface, the marker comprising:
a base portion configured to extend in a direction orthogonal to the work surface and include a recessed portion formed in a surface facing the positioning portion; and
an annular flange portion configured to protrude outward from the base portion in a plan view of the work surface, wherein
the marker is configured to align with the positioning portion by insertion of the positioning portion into the recessed portion.

10. A calibration method in a robot system including a robot including a robot arm and a positioning portion disposed at a tip end portion of the robot arm,
a marker that is disposed on a work surface, is configured to slide with respect to the work surface, and is configured to engage with the positioning portion, and
an imaging device configured to image the marker, for performing calibration between a robot coordinate system set in the robot and an image coordinate system set in the imaging device, the method comprising:
driving the robot arm and engaging the positioning portion with the marker, thereby aligning the marker with the positioning portion, and acquiring a first position that is a position of the positioning portion in the robot coordinate system;
imaging the marker after the alignment using the imaging device and acquiring a second position that is a position of the marker in the image coordinate system, based on an obtained image; and
performing calibration between the robot coordinate system and the image coordinate system based on the first position and the second position.
